(19) United States
(12) Patent Application Publication
(10) Pub. No.: US 2008/0294402 A1
(43) Pub. Date: Nov. 27, 2008

(54) Method for analyzing fluid flow within a three-dimensional object

(75) Inventor: Antonino Moroni, Rescaldina (IT)

Correspondence Address: GRIMES & BATTERSBY, LLP, 488 MAIN AVENUE, THIRD FLOOR, NORWALK, CT, 06851, US

(73) Assignee: Vero International Software UK Ltd.

(21) Appl. No.: 11/805,566

(22) Filed: May 23, 2007

(51) Int. Cl. G06G 7/50

(52) U.S. Cl. 703/9

(57) ABSTRACT

A flow analysis system is provided comprising a fully automatic and dynamic system for performing flow analysis on solid models. The system combines aspects of the mid-plane generation and prismatic filling systems in a way that is transparent to the user. The generation of a mid-plane mesh and the flow analysis of the mesh proceed in parallel. The analysis can be halted at any stage, at which point the user can visualize the results of the partial analysis. The data on which the analysis is being performed, the mid-plane mesh, is totally invisible to the user. This system also uses prismatic solid mesh generation to give the user the ability to view cross sections of the models after the analysis stage.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

A. Field of the Invention

The present invention relates to a method for analyzing fluid flow within a three-dimensional object, and more particularly to an automated flow analysis system, and, even more particularly, to a mid-plane flow analysis system wherein the generation of the mid-plane mesh and the analysis of the mid-plane mesh are synchronous dynamic operations.

Injection molding is one of the most productive industrial processes used to produce plastic objects.

Its advantage over other manufacturing process include the ability to produce both large and small complex parts, with aesthetic contours and restrictive tolerances. It enables high volume production without the need for secondary finishing operations using highly automated techniques.

The process is based on the melting of plastic polymer, which is rapidly injected into a cold cavity that represents the shape of the product. The plastic is then cooled within the cavity under pressure until it is sufficiently rigid to be removed.

The traditional manner of mold design is through an iterative trial and error technique, i.e., build the mold, mold the part and then check the quality of the resulting item. If it is below standard, then first of all try to modify the molding conditions. If the quality remains unsatisfactory, then redesign the mold, and if this should fail then perhaps it becomes necessary to redesign the part. This is a slow and costly process.

The purpose of programs such as VISI-Flow is to analyze the plastic injection process in advance of building the mold itself. This analysis is related both to the quality of the part itself (surface quality, effects of distortion and shrinkage) and well as the definition of the molding process. (Injection pressure, temperature, mold ejection etc). This analysis enables all concerned in the process to evaluate and refine their production techniques prior to building the mold itself.

The physics of the process is very complex. The analysis of a dynamic non isothermal flow of a non Newtonian fluid is a computationally intensive process and is typically based on finite element mathematics. The geometry of the part is broken into small portions, triangles or quadrilaterals for surface models (shell) or tetrahedral or hexahedral prisms for solid models. Each of these finite elements share common vertices with their neighboring elements. This is the so called ‘mesh’ or finite element representation of the part model. On each node of the mesh a series of equations describing the thermal, mechanical and mass balance properties are created, forming enormous systems of equations that must be solved to obtain the variable describing a process, be it pressure, temperature, density, velocity, etc.

B. Description of the Prior Art

Flow analysis is a complex task that demands high levels of skill and judgment from those who use it, and is a task that can only realistically be performed using computer models. Using a mid-plane analysis system, the users of the software must create the mid-plane from their analysis of the model. It is a semi-manual task where the user must examine corresponding upper and lower faces and generate the mid-plane based on the geometry and topology of the selected faces. As a moulded part typically consists of hundreds or thousands of faces this is a laborious and error prone task. The quality of the mid-plane mesh can vary widely between different operators and as a result there are also wide variations on the flow analysis itself. The generation of the mid-plane mesh and its subsequent analysis are sequential operations—the analysis cannot start until the mesh is complete.

Flow analysis of a cavity within a solid model is typically performed in one of three ways: shell analysis, solid analysis and Moldflow.

Shell analysis requires a representation of the mid-plane of the cavity by a grid that is composed of many triangular or quadrilateral patches (finite elements). Adjacent patches share common vertices, and each finite element is assigned attributes. These attributes include properties such as thickness, type of element, etc. Once the grid or mid-plane mesh is generated, the analysis can begin. As a moulded part typically consists of hundreds of surfaces the generation of the mid-plane surfaces requires a lot of manual work and the process becomes a laborious manual and error prone task.

An alternative solution is the prismatic or solid filling method, which is equivalent to filling the cavity with hexahedral or tetrahedral prisms. Using these prismatic shapes it is possible to interpolate between the upper and lower faces of the body. There must be an absolute minimum of 3 prisms between upper and lower faces, and typically there are 6 or more. In this case the generation of the solid mesh is automatic, but the volume of data is immense. The computation time for the flow analysis is very long, and in the majority of cases unacceptable in an industrial environment.

The Moldflow method utilizes only the outer surfaces defining the three dimensional object to create a computational domain. These correspond to representations of the domain in which flow is to be simulated, and would comprise, for example, meshed representations of the top and bottom surfaces of a part. Thus, the method could be said to utilize an outer skin mesh rather than a mid-plane mesh. Elements of the two surfaces are matched, based on the ability to identify a thickness between such elements. An analysis is then performed of the flow in each of these domains in which flow is to be simulated, but linked to ensure fidelity with the physical reality being modeled.

Moldflow requires that at least 85% of the upper and lower faces have opposing triangles if it is to be successful. Where opposing triangles cannot be found the process becomes a manual task. The user must examine corresponding upper and lower faces and generate the grid based on the geometry and topology of the selected faces.

An example of the Moldflow method is shown in U.S. Pat. No. 6,096,088, which issued to Yu, et al. on Aug. 1, 2000 for “Method for modeling three dimensional objects and simulation of fluid flow.” The patent describes matching each element of a first surface with an element of a second surface between which a reasonable thickness may be defined, wherein matched elements of the first surface constitute a first set of matched elements and matched elements of the second surface constitute a second set of matched elements, specifying a fluid injection point, and performing a flow analysis using each set of the matched elements. The injection point is linked to all locations on the first and second surfaces from which flow may emanate such that resulting flow fronts along the first and second surfaces are synchronized.

The shell analysis method is described in various publications, including the following:
Broyer E., Gutfinger C., Tadmor Z.
A theoretical Model for the Cavity Filling Process in Injection molding
Transactions Of The Society Of Rheology 19-8 423-444 (1975)
Tadmor Z., Gogos C. G.
Principles of Polymer Processing
John Wiley & Sons, 1979
Mavridis H., Hrymak A. N., Vlachopoulos J.
Mathematical Modelling of Injection Mold Filling: a Review Advances in Polymer Technology, Vol. 6, No. 4, 457-466 (1986)
Sitter C. W. M.
Numerical Simulation Of Injection Moulding
Non-isothermal non-Newtonian flow of polymers in complex geometries
Thesis at Technical University of Eindhoven—Nederland 23 Feb. 1988
Tucker III C. L. Editor
Computer Modeling for Polymer Processing:
Fundamentals
Carl Hanser Verlag. Munich, Vienna, New York 1989

Relevant publications describing the solid analysis include the following:
Inoue Y., Higashi T., Marsuoka T.
Numerical simulation of 3-Dimensional flow in Injection Molding
Annual National Technical Conference (ANTEC) 1996
Garcia-Rejon A., Hetu J. F., Pecora L.
3-D Mould Filling Of a Transfer Sprocket
ANTEC 1998

As will be appreciated, none of these prior patents even address the problem faced by applicant let alone offer the solutions proposed herein.

### SUMMARY OF THE INVENTION

Against the foregoing background, it is a primary object of the present invention to provide an automated mid-plane flow analysis system for analyzing fluid flow within a three-dimensional object.

It is another object of the present invention to provide such an automated flow analysis system wherein the generation of the mid-plane mesh and the analysis of the mid-plane mesh are synchronous dynamic operations.

It is yet another object of the present invention to provide such an automated flow analysis system that is more rapid than traditional Moldflow analysis.

It is still another object of the present invention to provide such an automated flow analysis system that requires no manual user intervention.

It is another object of the present invention to provide such an automated flow analysis system that generates consistent results.

It is another object of the present invention to provide such an automated flow analysis system that provides an analysis that is far less dependent upon the skills of the operator than traditional methods.

It is still another object of the present invention to provide such an automated flow analysis system that does not require large volumes of data and long computation time.

It is another object of the present invention to provide such an automated flow analysis system that combines aspects of the mid-plane generation and prismatic filling in a way that is transparent to a user.

It is yet another object of the present invention to provide such an automated flow analysis system that does not depend on any manual methods or triangle matching.

It is still another object of the present invention to provide such an automated flow analysis system that uses prismatic solid mesh generation to give the user the ability to view cross sections of the models after the analysis stage.

To the accomplishments of the foregoing objects and advantages, the present invention, in brief summary comprises a fully automatic and dynamic system for performing flow analysis on solid models. The system combines aspects of the mid-plane generation and prismatic filling systems in a way that is transparent to the user. The generation of a mid-plane mesh and the flow analysis of the mesh proceed in parallel. The analysis can be halted at any stage, at which point the user can visualize the results of the partial analysis. The data on which the analysis is being performed, the mid-plane mesh, is totally invisible to the user. This system also uses prismatic solid mesh generation to give the user the ability to view cross sections of the models after the analysis stage.

### BRIEF DESCRIPTION OF THE DRAWINGS

The foregoing and still other objects and advantages of the present invention will be more apparent from the detailed explanation of the preferred embodiments of the invention in connection with the accompanying drawings, wherein:

FIG. 1 is a flow chart demonstrating the flow analysis system of the present invention;

FIG. 2 is an isometric view of a plate with triangulated surfaces; and

FIG. 3 is a top plan view of a shell mesh.

### DETAILED DESCRIPTION OF THE PREFERRED EMBODIMENTS

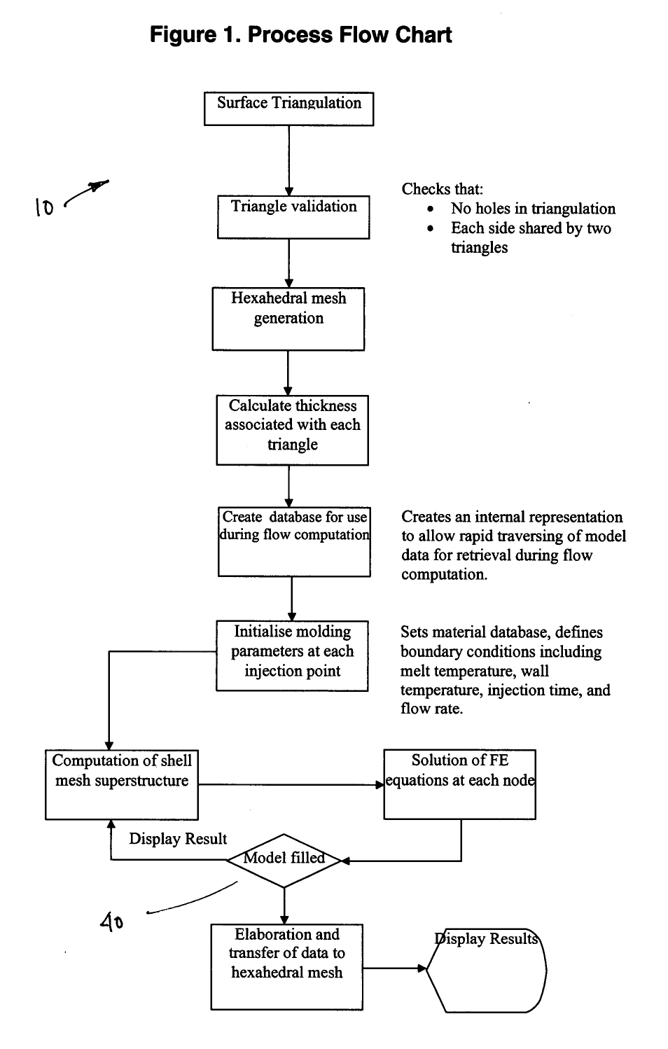

Referring to the drawings and, in particular, to FIG. 1 thereof, the flow analysis system of the present invention is provided and is referred to generally by reference numeral 10. The system 10 combines aspects of the mid-plane generation and prismatic filling systems in a way that is transparent to the user.

The system 10 of the present invention calculates the mid-plane mesh or shell mesh of a three-dimensional object in two stages. The first stage is to triangulate the faces of the solid model. FIG. 3 illustrates such a triangulated structure 20. It should be noted that the triangles 30 are very varied in size and shape. Some will be isosceles, some equilateral, and others will be long and thin. The triangle shapes depends upon the geometry of the part, and each triangle has an associated thickness.

The system 10 uses this triangulated structure to construct a solid mesh 40 that is used when the analysis is complete to provide feedback on the flow at cross sections of the model.

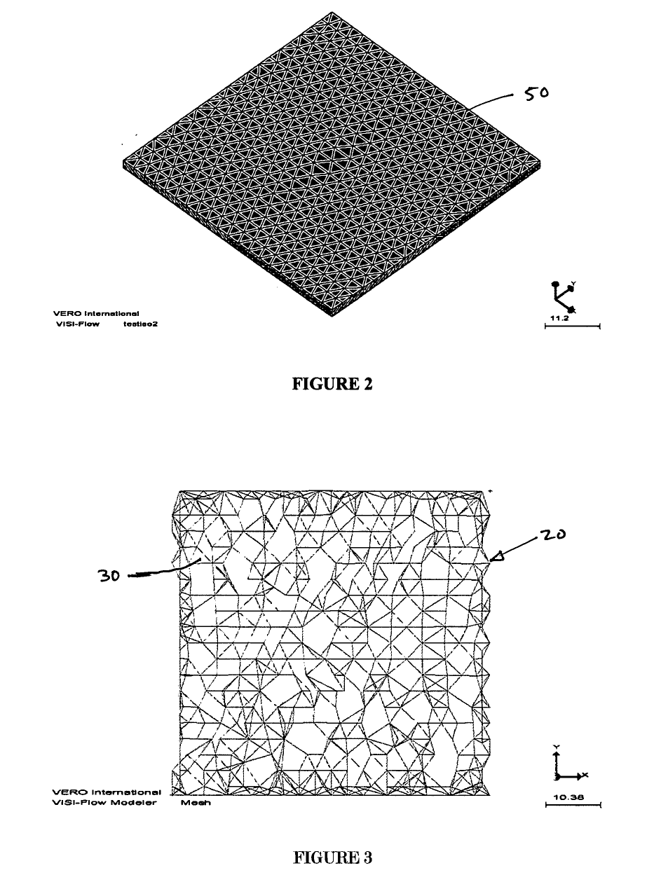

The user provides one or more entry points for injected material, after which the system 10 uses the external triangulation 20 to construct a mid-plane or shell mesh 50 created through the definition of a SuperStructure composed by associating properties that are derived from the outer shell, including thickness, the distance between start and end nodes, etc. The mid-plane or shell mesh 50 is illustrated in FIG. 2. It should be appreciated that there is no need for user intervention since this method does not rely on matching opposing triangles as is required in the prior art. This shell mesh grows dynamically until it fills the cavities of the three-dimensional object

Simultaneously with the propagation of the mesh, the system also performs flow analysis.

When the process is completed the results (pressure, temperature etc) are transferred to the user through the outer shell.

The system and method of the present invention automatically creates a solid hexahedral mesh by creating a grid on the XY plane under the triangularized part. The grid step is based on the physical size of the model and other criteria. For each node on the grid a ray is projected through the model and a column of hexahedrons is generated between where the ray enters the model and where it leaves. The process is applied to every grid node until completion. The technique is fast and precise.

During the calculation phase the mid-plane shell mesh is developed with an associated superstructure. Finite element methods are applied to this mesh to solve the issues of plastic flow within the 3 dimensional model.

Starting at the vertices at which plastic is injected the application incrementally creates a superstructure. The superstructure has attributes such as distance between vertices and the distance to the triangles opposite to the one under consideration. As soon as each portion of the mesh is generated, the analysis on the actual plastic injection is performed. The node reached by the fluid then becomes the start position for the next iteration. Thus, if the mesh generation is interrupted, then the plastic analysis of the component is available up to that stage.

Having thus described the invention with particular reference to the preferred forms thereof, it will be obvious that various changes and modifications can be made therein without departing from the spirit and scope of the present invention as defined by the appended claims.

Wherefor I claim:

1. A method for analyzing flow on a three-dimensional solid model having a varied topography including cavities, said method comprising the steps of:
triangulating faces of said solid model, to thereby create a triangulated surfaces, said faces corresponding to said topography;
constructing a solid mesh from said triangulated faces;
constructing a shell mesh from said triangulated faces simultaneously growing said shell mesh to dynamically fill said cavities while performing a flow analysis of said shell mesh; and
communicating the results of said analysis to a user.

2. The method of claim 1, further including the step of using said solid mesh to provide visual feedback on cross sections of the model after analysis is complete.

3. The method of claim 1, wherein step of constructing said shell mesh is performed without user intervention.

4. The method of claim 1, wherein said method is fully automatic and dynamic.

5. The method of claim 1, further including the step of providing a user with a visualization of said flow analysis as said shell mesh is being propagated.

6. The method of claim 1, further including the step of allowing a user to view cross-sections of said solid model after the analysis stage.

7. The method of claim 1, wherein said triangulated faces vary in size, shape and thickness depending on the geometry of said solid model.

8. The method of claim 1, further including the step of a user providing one or more entry points prior to the step of constructing said shell mesh.

9. A fully automatic and dynamic method for analyzing flow on a three-dimensional solid model having a varied topography including cavities, said method comprising the steps of:
triangulating faces of said solid model, to thereby create a triangulated surfaces, said faces varying in size, shape and thickness and corresponding to said topography;
constructing a solid mesh from said triangulated faces;
providing feedback on flow at said cross sections after analysis is complete;
constructing a shell mesh from said triangulated faces without user intervention;
simultaneously growing said shell mesh to dynamically fill said cavities while performing a flow analysis of said shell mesh;
providing a user with a visualization of said flow analysis as said shell mesh is being propagated; and
communicating the results of said analysis to a user.
